(19) United States
(12) Patent Application Publication
(10) Pub. No.: US 2017/0046744 A1
(43) Pub. Date: Feb. 16, 2017

(54) Exposure-Based Advertising System and Method

(71) Applicants: Weibin Li, Chengdu (CN); Xiaojian Niu, Chengdu (CN)

(72) Inventors: Weibin Li, Chengdu (CN); Xiaojian Niu, Chengdu (CN)

(21) Appl. No.: 14/823,056

(22) Filed: Aug. 11, 2015

(51) Int. Cl. G06Q 30/02

(52) U.S. Cl. CPC G06Q 30/0267; G06Q 30/0207

(57) ABSTRACT

The disclosure provides an exposure-based advertising system, which comprises a tag, a mobile device, and a server. The tag comprises a signal transmitter for sending a signal encoding an identifier, a power supply for supplying power to the signal transmitter, and a signage; wherein the signal transmitter and the power supply are adhered at least partially to the signage. The mobile device is configured to receiving the signal transmitted from the tag, decoding the signal into an identifier, and record data associated with the identifier. The server is configured to communicate with the mobile device for determining a reward according to the data associated with the identifier and releasing the reward to the mobile device. An exposure-based advertising method is also provided. The exposure-based advertising system and method of the present disclosure offers effective advertisement exposure, high consumer acceptance, and strong incentive to engage.

### FIELD OF THE INVENTION

The present invention relates to an advertising system and method, and more particularly to an exposure-based advertising system and method.

### BACKGROUND OF THE INVENTION

Conventional approaches of advertising include printed mails, newspapers, magazines, yellow pages, posters, TV commercials, radio broadcasting, and vehicle advertising. As the Internet and portable devices emerge, e-mails, text messages, website pop messages, and webpage-side ads have become increasingly more common and favorable methods of advertising. However, most of the traditional advertising methods are non-targeting, aiming to reach the largest possible reader or audience with limited selectivity. Internet-based methods using targeted advertising cookies are more selective, but are mostly ignorable and may potentially cause unpleasant web browsing experience and thus negative impression among Internet users. Therefore, there is a need for an advertising method that results in effective advertisement exposure, high consumer acceptance, and strong incentive to engage.

To increase exposure and enhance consumers' incentive to engage, Litwin in U.S. Pat. No. 6,374,228 B1 (2002) revealed a rebate method involving embedding bumper sticker advertisements with bar codes, transmitters, or LED lights and installing tracking devices at designated locations that provides rebates to individuals associated with the bumper sticker advertisements. Thereafter, Walwer in U.S. Pat. No. 8,712,630 B2 (2014) revealed tracking of vehicle advertising performance by the global positioning system (GPS) and calculating and disbursing payments to drivers from a centralized source to avoid fraudulent manipulation of the drivers for increased compensation. However, methods disclosed by Litwin and Walwer involve expensive installation and high operational cost, and are yet non-targeting and non-selective.

### SUMMARY OF THE INVENTION

Therefore, the present invention provides an exposure-based advertising system and method that offers effective advertisement exposure, high consumer acceptance, and strong incentive to engage.

The present invention provides an exposure-based advertising system, including a tag, a mobile device, and a server. The tag includes a signal transmitter for sending a signal encoding at least one identifier, a power supply for supplying power to the signal transmitter, and a signage having a front surface and a back surface, wherein the signal transmitter and the power supply are adhered at least partially to the signage. The mobile device is configured for receiving the signal transmitted from the tag, decoding the signal into at least one identifier, and recording data associated with the at least one identifier. The server is configured to communicate with the mobile device for determining a reward according to the data associated with the at least one identifier and releasing the reward to the mobile device.

The present invention also provides an exposure-based advertising method, including the steps of: displaying a tag, wherein the tag comprises a signage and a signal transmitter for sending a signal encoding at least one identifier; receiving the signal transmitted from the tag and decoding the signal into at least one identifier; recording data associated with the at least one identifier; and determining a reward according to the data associated with the at least one identifier and releasing the reward.

The present invention advances existing advertising systems and methods by integrating conventional bumper sticker-sized advertisements with RFID tracking system, mobile devices, and GPS locator system. The exposure-based advertising system and method of the present invention offers a simple, effective, cost-efficient, and mutually beneficial system to distribute advertisements or messages. The present invention also provides reliable information on consumer behaviors and advertisement exposure effectiveness, critical for developing successful business strategies. In addition to commercial applications, the present invention also presents a powerful tracking system useful for law enforcement authorities to more efficiently locate stolen or suspicious vehicles, missing children, or other victims of common crimes.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is an exemplary illustration of an embodiment of an exposure-based advertising system of the present invention;

FIG. 2 is an exploded view of a tag of the exposure-based advertising system of the present invention;

FIG. 3 is a flow diagram of the steps of an embodiment of an exposure-based advertising method of the present invention;

FIG. 4 is an exemplary illustration of the embodiment of an exposure-based advertising system of the present invention; and

FIG. 5 is an exemplary illustration of three reward mechanisms of the embodiment of the exposure-based advertising method of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

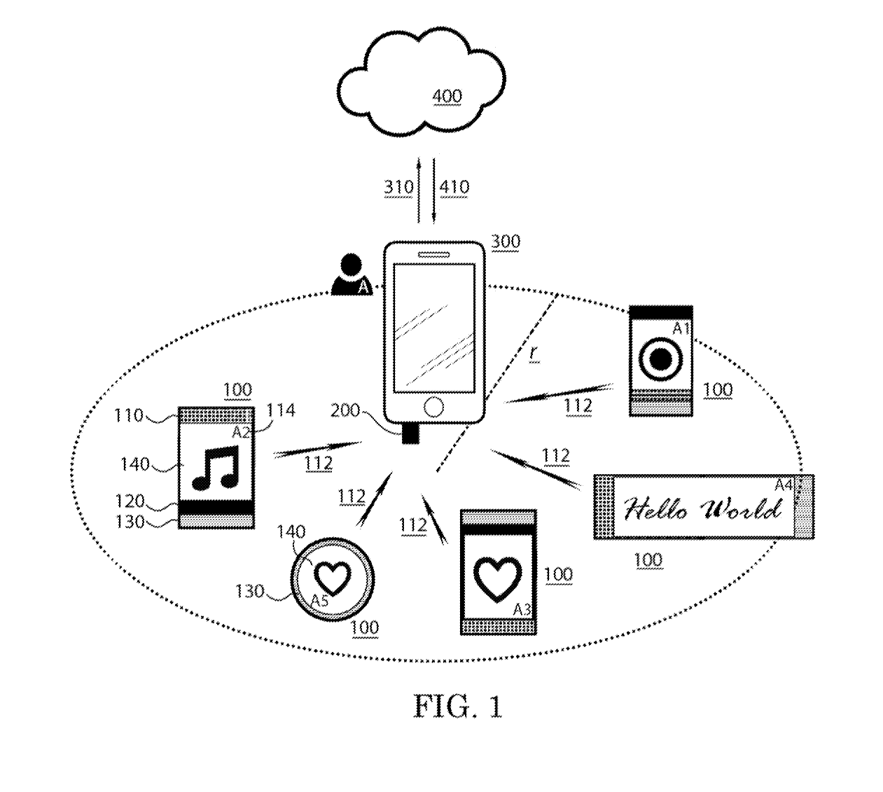

Referring now to FIG. 1, which provides an exemplary illustration of an embodiment of an exposure-based advertising system of the present invention. As shown in FIG. 1, the exposure-based advertising system includes a tag 100, a signal receiver 200, a mobile device 300, and a server 400.

The tag 100 includes a signal transmitter 110, a power supply 120, a power generator 130, and a signage 140. The signal transmitter 110 is configured for sending a signal 112 encoding at least one identifier 114. In this embodiment, the signal transmitter 110 is a radiofrequency (RF) transmitter and the signal 112 is a radiofrequency signal. In other embodiments, the signal 112 may be, but not limited to, a laser, infrared, or electromagnetic signal.

The power supply 120 is configured for supplying power to the signal transmitter 110, and may be, but not limited to, a standard button battery. To ensure sufficient public exposure of the tag 100, storage capacity of the power supply 120 may be configured to sustain the signal transmitter 110 preferably for no longer than 24 hours. Consequently, the power supply 120 may be electrically coupled to a power generator 130 and configured to store electricity generated by the power generator 130. In this embodiment, the power generator 130 coupled to the power supply 120 of weak storage capacity is preferably a solar panel, such that users of the exposure-based advertising system of the present invention are prompted to expose their assigned tags in outdoor spaces or spaces with sufficient lighting, therefore increasing public exposure. In other embodiments, the power supply 120 may be charged electromagnetically. It is to be understood that methods of power generation for the tag 100 of the present invention is not limited thereto and shall be adjusted according to actual needs.

The signage 140 has a front surface and a back surface. As shown in FIG. 1, the front surface of the signage 140 may include, but not limited to, a printed image, an advertisement, a logo, a trademark, a slogan, or an icon. In other embodiments, the front surface of the signage 140 may include at least one of a printed image, a light emitting device, a display device, or combinations thereof, for displaying a short promotional video or a news update. As illustrated in FIG. 1, size, shape, and color of the signage 140 may vary according to cost and design considerations of the advertising sponsors. Particularly, size and shape of the signage 140 may resemble, but not limited to, a standard bumper sticker; and a panel of colors may be utilized as a visual representation of different tiers of the tag 100, so as to provide the users a sense of competition and engagement. It is to be understood that tags 100 and signages 140 illustrated in FIG. 1 are merely exemplary and shall not be construed as limiting the scope of the present invention.

The signal transmitter 110, the power supply 120, and the power generator 130 may be adjustably arranged around the signage 140 according to the size and shape of the signage 140, and are adhered at least partially to the signage 140 such that all required elements are stably connected to each other and presented in a form of a single tag.

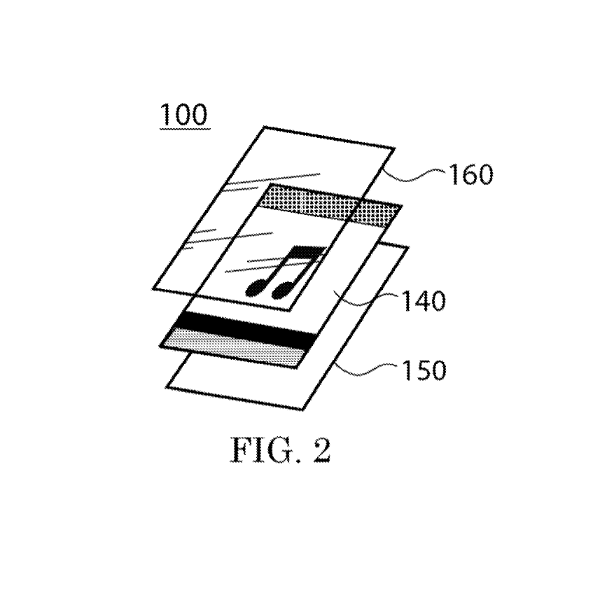

Referring now to FIG. 2, which illustrates an exploded view of a tag of the exposure-based advertising system of the present invention. As shown in FIG. 2, the tag 100 may further include a binding agent 150 adhered at least to the back surface of the signage 140, and a transparent material 160 for covering and protecting the signal transmitter 110, the power supply 120, the power generator 130, and the front surface of the signage 140. The binding agent 150 may be, but not limited to, a magnetic material or a polymeric material. The transparent material 160 may be, but not limited to, clear vinyl. With an adhesive back and a protective covering, the tag 100 may be displayed on vehicles, bags, children, pets, or any movable belongings of the users of the exposure-based advertising system of the present invention. To maximize public exposure, the tag 100 may also be encased in a clear casing so that the tag 100 can be displayed on arms or other body parts when the users jog or walk in public spaces.

Referring again to FIG. 1, the identifier 114 includes a personal identification code (ID) and a signage ID. For example, an individual A is a member of the exposure-based advertising system of the present invention. Each tag 100 being assigned to the individual A is encoded a personal ID associated with the individual A and a signage ID associated with a sponsor of the signage 140. In other embodiments, information encoded in the identifier 114 of the tag 100 may further include size of the tag 100 and tier code of the tag 100, but is not limited thereto.

The signal receiver 200 is configured for receiving the signal 112 transmitted from the tag 100 and decoding the signal 112 into at least one identifier 114. In this embodiment, the signal transmitter 110 is a RF transmitter and the signal 112 is a RF signal. In other embodiments, the signal 112 may be, but not limited to, a laser, infrared, or electromagnetic signal. To ensure user engagement and effective visual exposure, transmission of the RF signal by the signal transmitter 110 and reception of the RF signal by the signal receiver 200 is preferably limited to a radius r, such as 10 meters.

The mobile device 300 is electrically coupled to the signal receiver 200. The signal receiver 200 may be a built-in element or function in the mobile device 300, or alternatively, a plug-in device pluggable to the mobile device 300 as illustrated in FIG. 1. A connection is established among the signal transmitter 110, the signal receiver 200, and the mobile device 300 when the mobile device 300 coupled with the signal receiver 200 is present within the radius r surrounding the signal transmitter 110. In contrast, a disconnection is reported when the mobile device 300 coupled with the signal receiver 200 is present outside of the radius r.

The plug-in signal receiver 200 may further include an inlet (not shown) for an audio device (not shown) to connect to the mobile device 300, so that audio functions of the mobile device 300 remain available when the signal receiver 200 is plugged in to the mobile device 300. Additionally, a chip (not shown) capable of receiving global positioning signals from a global navigation satellite system may be built into the signal receiver 200 when global positioning function is not available in the mobile device 300.

In this embodiment, the individual associated with the mobile device 300 would be asked to download and install an application of the present invention, which is configured to decode the identifier 114 and record data associated with the identifier 114. The data 310 associated with the identifier 114 includes, but not limited to, size of the tag 100, tier code of the tag 100, sponsor of the signage 140, location of the mobile device 300, travel route of the mobile device 300, distance of travel of the mobile device 300, and duration of travel of the mobile device 300.

The data 310 is sent to the server 400 communicating with the mobile device 300 upon completion of data collection or at a default time for determination of a reward 410 according to contents of the data 310. The reward 410 would then be released to the mobile device 300.

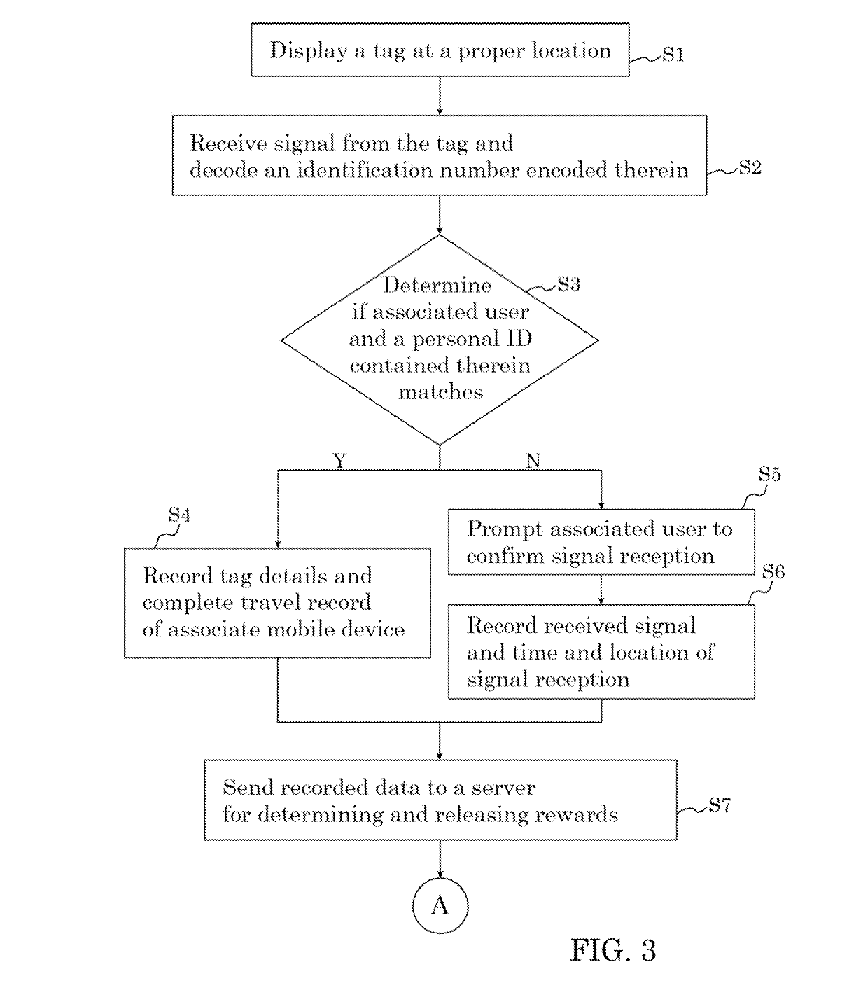

Referring now to FIG. 3, which illustrates the steps of an embodiment of an exposure-based advertising method of the present invention. As shown in FIGS. 1 and 3, the exposure-based advertising method includes the steps of:

S1—displaying the tag 100 at a proper location. The tag 100 may be displayed on vehicles, bags, or any movable belongings of the users. To maximize public exposure, the tag 100 may also be encased in a clear casing so that the tag 100 can be displayed on arms or other body parts when the users jog or walk in public spaces.

S2—the mobile device 300 receiving the signal 112 transmitted from the tag 100 and decoding the signal 112 into at least one identifier 114. The mobile device 300 may have a built-in element or function for signal reception, or alternatively, may couple to a plug-in device pluggable to the mobile device 300, as illustrated in FIG. 1. Information encoded in the identifier 114 of the tag 100 may include a personal ID associated with the user, a signage ID associated with a sponsor of the signage 140, size of the tag 100, and tier code of the tag 100, but is not limited thereto. In other embodiments, S2 may further include a step of receiving a positioning signal from a global navigation satellite system. Additionally, reception of the signal 112 is preferably limited to a radius r, such as 10 meters.

S3—determining if an associated user of the mobile device 300 matches an individual associated with the personal ID encoded in the identifier 114.

S4—if the associated user of the mobile device 300 matches the individual associated with the personal ID encoded in the identifier 114, recording data associated with the identifier 114. The data 310 associated with the identifier 114 includes, but not limited to, size of the tag 100, tier code of the tag 100, sponsor of the signage 140, location of the mobile device 300, travel route of the mobile device 300, distance of travel of the mobile device 300, and duration of travel of the mobile device 300.

S5—if the associated user of the mobile device 300 does not match the individual associated with the personal ID encoded in the identifier 114, prompting the associated user to confirm signal reception by displaying on the screen of the mobile device 300 a copy of the image or video of the received signage ID encoded in the identifier 114. The corresponding signage 140 may be an advertisement, a logo, a trademark, a slogan, a short promotional video, or combinations thereof. To ensure effective advertisement exposure, the screen display may be accompanied by an alert ringtone, reminding the associated user to confirm signal reception in time. The screen display may be configured to stay on the screen for a limited amount of time or go away upon completion of a single or a series of actions as instructed, such as clicking a button, sliding to unlock, or watching a short promotional video.

S6—upon confirmation of signal reception, recording the received identifier 114, tier code of the tag 100, time of signal reception, and location of the mobile device 300.

S7—sending the recorded data to a server 400 for determining a reward for the mobile device 300.

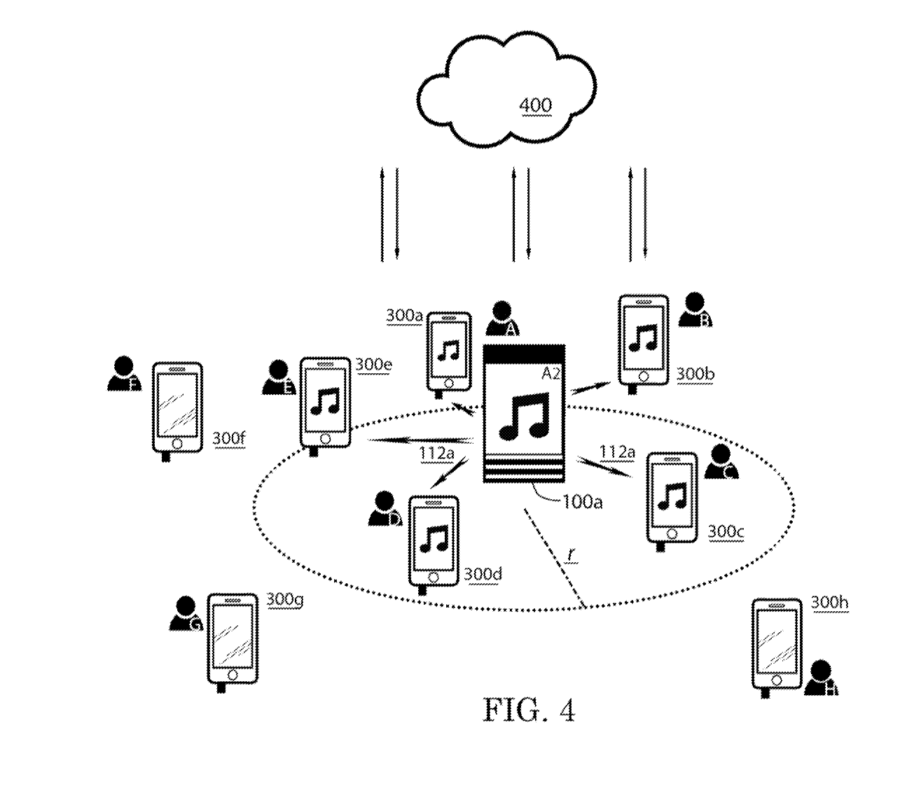

Referring now to FIG. 4, which provides an exemplary illustration of the embodiment of the exposure-based advertising system of the present invention. In the example illustrated in FIG. 4, individuals A-H are all members of the exposure-based advertising system of the present invention. Each of the 8 individuals carries a mobile device 300a-300h with a signal receiver 200 plugged thereto and an application of the present invention operated therein. Individual A displays amongst individuals B-H a tag 100a encoding an identifier A2, wherein ‘A’ represents the personal ID and ‘2’ represents the signage ID in this example. Mobile devices 300b-300e associated with individuals B-E presenting within a radius r surrounding tag 100a would automatically display an image of signage ID 2 upon reception of the signal 112a transmitted from tag 100a. In contrast, mobile devices 300f-300h associated with individuals F-H presenting outside of the radius r surrounding tag 100a would not display the image of signage ID 2. Preferably, to ensure user identity authenticity and avoid fraudulent conduct, mobile devices 300b-300e associated with individuals B-E would receive the signal 112a transmitted from tag 100a only when connection between tag 100a and mobile device 300a associated with individual A is established and current.

It is to be understood that FIG. 4 merely illustrates the simplest example of the exposure-based system and method of the present invention. In an actual situation, a mobile device presenting in a public space may receive multiple signals from multiple tags simultaneously or within a time frame. A list of received signals may be displayed on the screen of the mobile device, prompting the user associated with the mobile device to complete one by one the instructed actions required by the received signals, such as clicking a button, sliding to unlock, or watching a short promotional video, in order to confirm reception of each of the signals.

Referring again to FIG. 4, once individuals B-E confirm reception of the signal 112a transmitted from tag 100a by completing the actions as instructed, such as clicking a button or sliding to unlock, mobile devices 300b-300e would record the received identifier A2, the tier code of tag 100a, time of signal reception, and location of the mobile devices 300e-300e, which are then sent to the server 400 for reward calculation. In other embodiments, reception of certain tags or advertisements may be blocked by users from their associated mobile devices 300 or by the server 400 upon users' requests.

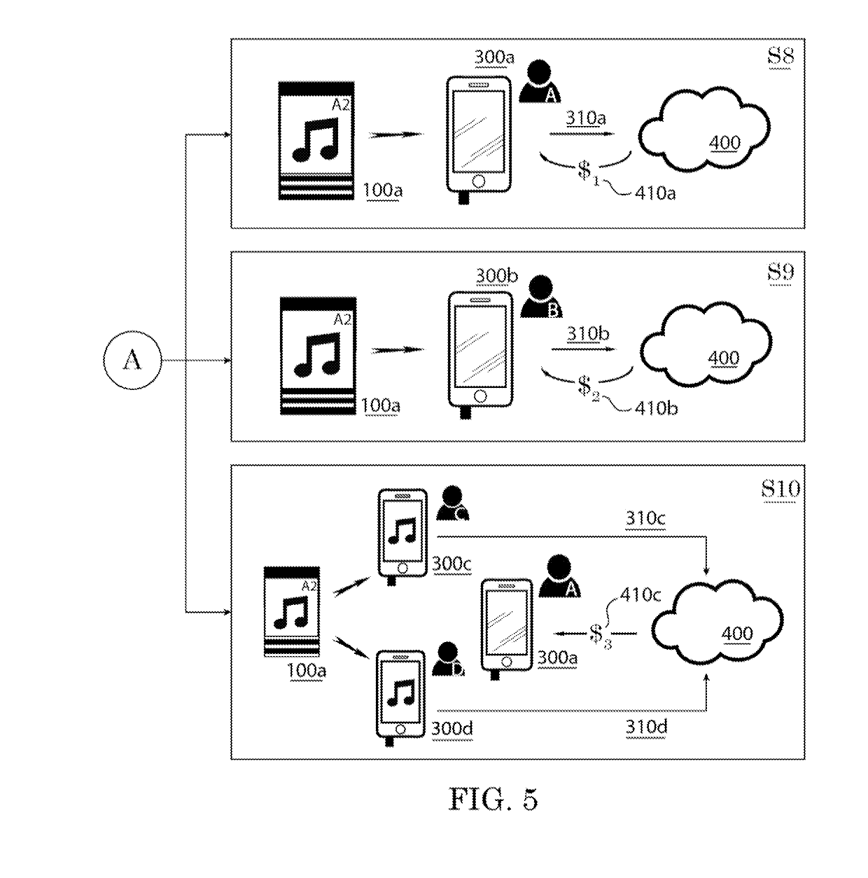

Referring now to FIG. 5, which illustrates three exemplary reward mechanisms of the embodiment of the exposure-based advertising method of the present invention. As shown in FIG. 5, determining a reward according to the data associated with the identifier and releasing the reward includes the steps of:

S8—if an associated user A of the mobile device 300a matches an individual associated with a personal ID A encoded in the tag 100a, the server 400 calculates a first reward 410a according to recorded data 310a associated with identifier A2, including but not limiting to size of tag 100a, tier code of tag 100a, sponsor of the signage 2, location of the mobile device 300a, travel route of the mobile device 300a, distance of travel of the mobile device 300a, and duration of travel of the mobile device 300a. Preferably, the server 400 releases the first reward 410a to the mobile device 300a on a monthly basis.

S9—In contrast, if an associated user B of the mobile device 300b does not match the individual associated with the personal ID A encoded in the tag 100a, the server 400 calculates a second reward 410b according to recorded data 310b, including but not limiting to the received identifier A2, size of tag 100a, tier code of the tag 100a, time of signal reception, and location of the mobile device 300b. Preferably, the server 400 releases the second reward 410b of a predetermined amount to the mobile device 300b for only a limited number of times per day.

S10—the server 400 may also calculate, preferably monthly, the number of times tag 100a is read, within a month in this example, by a mobile device associated with a user not matching the personal ID A of tag A2; that is, mobile devices 300c and 300d in this example. To be qualified as a countable read, signal transmitted by tag 100a must have been received and confirmed reception by users C and D. The server 400 would release a third reward 410c to mobile device 300a based on the calculated number of exposure to others of tag 100a, size of tag 100a, sponsor of the signage ID 2, and tier code of tag 100a, preferably on a monthly basis.

It is to be understood that the three reward mechanisms illustrated in FIG. 5 are merely exemplary and shall not be construed as limiting the scope of the present invention. In some embodiments, the rewards may be provided in the form of cash, or preferably credits or coupons redeemable at designated websites or online and/or offline stores. To enhance the sense of competition and thus stimulate user base growth, mobile device application or website of the exposure-based advertising system of the present invention may publish monthly or weekly rankings of the most frequently exposed tag numbers, tags that have traveled the furthest or the longest, the highest rewarded users, etc.

Additionally, in a preferred embodiment, an alert function is built into the mobile device 300 or the signal receiver 200 to alert associated users connection and disconnection between the signal transmitter 110 and the signal receiver 200 or the mobile device 300, preferably with distinct alert ringtones. The alert function may be switched on and off manually. Consequently, in addition to commercial applications, an advantage of the exposure-based advertising system and method of the present invention is to provide a security alert when children, pets, or other valuable belongings are absent within a certain range from the associated user.

Likewise, the exposure-based advertising system and method of the present invention may also be useful for locating stolen or suspicious vehicles more efficiently. In a preferred embodiment, once a stolen vehicle is reported from a mobile device to the server, reception of signal transmitted from the tag attached to the stolen vehicle by any non-associated users would be reported to the server, thus obtaining the instant location of the stolen vehicle. Such application of the present invention may also be used to locate missing children or pets.

The exposure-based advertising system and method of the present invention advances existing advertising methods by integrating conventional bumper sticker-sized advertisements with RFID tracking system, mobile devices, and GPS locator system. In the present invention, bumper sticker-sized advertisements are added a RF signal transmitter and a solar panel for users to display on vehicles, bags, or any movable belongings; and each of the users is provided a RF signal receiver pluggable to a mobile device. Consequently, locations and routes in which the users travel with, and therefore publicly expose, their subscribed advertisements can be tracked; reception of other users' advertisements can be recorded; frequency of subscribed advertisements being exposed to other users can also be calculated. Such exposure records are thus utilized as the basis for reward determination.

Therefore, the present invention provides a simple, effective, cost-efficient, and mutually beneficial system to distribute advertisements or messages. The present invention also provides reliable information on consumer behaviors and advertisement exposure effectiveness, critical for developing successful business strategies. In addition to commercial applications, the present invention also presents a powerful tracking system useful for law enforcement authorities to more efficiently locate stolen or suspicious vehicles, missing children, or other victims of common crimes.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. An exposure-based advertising system, comprising:
a tag, comprising:
a signal transmitter, configured for sending a signal encoding at least one identifier;
a power supply, configured for supplying power to the signal transmitter; and
a signage, having a front surface and a back surface, wherein the signal transmitter and the power supply are adhered at least partially to the signage;
a mobile device, configured for receiving the signal transmitted from the tag, decoding the signal into at least one identifier, and recording data associated with the at least one identifier; and
a server, configured to communicate with the mobile device for determining a reward according to the data and releasing the reward to the mobile device.

2. The exposure-based advertising system according to claim 1, further comprising a signal receiver, electrically coupled to the mobile device and configured for receiving the signal transmitted from the tag and decoding the signal into the at least one identifier.

3. The exposure-based advertising system according to claim 2, wherein the signal receiver further comprises a chip, configured to receive positioning signals from a global navigation satellite system.

4. The exposure-based advertising system according to claim 1, wherein the signal transmitter is a radiofrequency transmitter and the signal is a radiofrequency signal.

5. The exposure-based advertising system according to claim 1, wherein the tag further comprises a power generator, electrically coupled to the power supply, the power supply stores electricity generated by the power generator.

6. The exposure-based advertising system according to claim 5, wherein the power generator is a solar panel.

7. The exposure-based advertising system according to claim 5, wherein the tag further comprises a binding agent, adhered at least to the back surface of the signage, wherein the binding agent is a magnetic material or a polymeric material.

8. The exposure-based advertising system according to claim 5, wherein the tag further comprises a transparent material, wherein the front surface of the signage is adhered to the transparent material.

9. The exposure-based advertising system according to claim 1, wherein the at least one identifier comprises a personal identification code (ID) and a signage ID.

10. The exposure-based advertising system according to claim 1, wherein the data comprises a size of the tag, a tier code of the tag, a sponsor of the signage, a location of the mobile device, a travel route of the mobile device, a distance of travel of the mobile device, and a duration of travel of the mobile device.

11. The exposure-based advertising system according to claim 1, wherein the front surface of the signage comprises at least one of a printed image, a light emitting device, a display device, or combinations thereof.

12. The exposure-based advertising system according to claim 2, wherein the signal receiver further comprises an inlet, for an audio device to connect to the mobile device.

13. An exposure-based advertising method, comprising the steps of:
displaying a tag, wherein the tag comprises a signage and a signal transmitter for sending a signal encoding at least one identifier;
receiving the signal transmitted from the tag and decoding the signal into the at least one identifier;
recording data associated with the at least one identifier; and
determining a reward according to the data associated with the at least one identifier and releasing the reward.

14. The exposure-based advertising method according to claim 13, wherein recording data associated with the at least one identifier further comprises the steps of:
determining if an associated user of a mobile device receiving the signal transmitted from the tag matches an individual associated with a personal identification code (ID) encoded in the at least one identifier,
if yes, recording the data associated with the at least one identifier, wherein the data comprises a size of the tag, a tier code of the tag, a sponsor of the signage, a location of a mobile device, a travel route of the mobile device, a distance of travel of the mobile device, and a duration of travel of the mobile device,
if no, recording at least the at least one identifier, the tier code of the tag, the time of signal reception, and the location of the mobile device.

15. The exposure-based advertising method according to claim 14, wherein if the associated user of the mobile device receiving the signal transmitted from the tag does not match the individual associated with the personal ID encoded in the at least one identifier further comprises the step of:
prompting the associated user to confirm reception of the signal.

16. The exposure-based advertising method according to claim 13, wherein determining a reward according to the data one and releasing the reward further comprises the steps of:
if an associated user of a mobile device matches an individual associated with a personal ID encoded in the at least one identifier, releasing a first reward calculated according to the data associated with the at least one identifier, wherein the data comprises a size of the tag, a tier code of the tag, a sponsor of the signage, a location of a mobile device, a travel route of the mobile device, a distance of travel of the mobile device, and a duration of travel of the mobile device;
if the associated user of the mobile device does not match the individual associated with the personal ID encoded in the at least one identifier, releasing a second reward according to a predetermined amount.

17. The exposure-based advertising method according to claim 13, wherein after determining a reward according to the data associated with the at least one identifier and releasing the reward further comprises the steps of:
calculating a number of times an identifier in a server is read by at least one mobile device associated with at least one user not matching a personal ID encoded in the identifier in the server; and
releasing a third reward to a mobile device associated with a user matching the personal ID encoded in the identifier in the server calculated according to the number of times the identifier in the server is read by the at least one mobile device, and a tag size, a tier code, and a sponsor associated with the identifier in the server.

18. The exposure-based advertising method according to claim 13, wherein the signal transmitter is a radiofrequency transmitter and the signal is a radiofrequency signal.

19. The exposure-based advertising method according to claim 13, wherein receiving the signal transmitted from the tag and decoding the signal into the at least one identifier further comprises the step of:
receiving a positioning signal from a global navigation satellite system.
